(19) United States
(12) Patent Application Publication
(10) Pub. No.: US 2022/0088504 A1
(43) Pub. Date: Mar. 24, 2022

(54) METHOD FOR EFFICIENTLY INDUCING PHASE SEPARATION OF WATER-ORGANIC SOLVENT MIXED SOLUTION THROUGH INORGANIC SALT

(71) Applicant: CHANGCHUN INSTITUTE OF APPLIED CHEMISTRY, CHINESE ACADEMY OF SCIENCE, Changchun, Jilin (CN)

(72) Inventors: Yuyuan LU, Changchun, Jilin (CN); Minglun LI, Changchun, Jilin (CN); Lijia AN, Changchun, Jilin (CN)

(73) Assignee: CHANGCHUN INSTITUTE OF APPLIED CHEMISTRY, CHINESE ACADEMY OF SCIENCE, Changchun, Jilin (CN)

(21) Appl. No.: 17/284,481

(22) PCT Filed: Jun. 4, 2020
(86) PCT No.: PCT/CN2020/094287

§ 371 Date: Apr. 12, 2021

(30) Foreign Application Priority Data
Dec. 25, 2019 (CN) 201911358256.9

(51) Int. Cl. B01D 17/04; B01F 31/80; B01D 17/12; G01N 30/74; G01N 30/06

(52) U.S. Cl. CPC B01D 17/047; B01F 31/80; B01F 2101/305; G01N 30/74; G01N 30/06; B01D 17/12

(57) ABSTRACT

The present disclosure provides a method for efficiently inducing phase separation of a water-organic solvent mixed solution through an inorganic salt, comprising the following steps: A) adding the inorganic salt to the water-organic matter mixed solution, sonicating and then allowing to stand for complete dissolution of the inorganic salt, wherein the water-organic matter mixed solution is a water-acetonitrile mixed solution or a water-acetone mixed solution; the inorganic salt is one or more of LiCl, NaCl, KCl, CsCl, NaBr, KBr, Li₂SO₄, Na₂SO₄ and MgSO₄; B) allowing the solution obtained in the step A) to stand in a constant temperature environment until phase separation is completed to obtain a product.

This application claims the priority of Chinese Patent Application No. 201911358256.9, titled “METHOD FOR EFFICIENTLY INDUCING PHASE SEPARATION OF WATER-ORGANIC SOLVENT MIXED SOLUTION THROUGH INORGANIC SALT”, filed with the Chinese State Intellectual Property Office on Dec. 25, 2019, the entire content of which is incorporated herein by reference.

### FIELD

The present disclosure belongs to the technical fields of physical chemistry and analytical chemistry, and particularly relates to a method for efficiently inducing phase separation of a water-organic solvent mixed solution through an inorganic salt.

### BACKGROUND

Adding a salt to a water-organic matter mixed solution can cause phase separation, and such a phenomenon is known as inorganic salt-induced phase separation. The discovery of this phenomenon provides a new method for material extraction. Compared with the traditional extraction method, this method can greatly improve the extraction efficiency. Meanwhile, it has many advantages such as low energy consumption, environmental protection, and convenient and fast experimental operation. In recent years, the methods of inorganic salt-induced phase separation have gradually developed into an important qualitative or quantitative analysis technique in analytical chemistry, which are widely used in the fields of food and medicine and so on. For example, inorganic salt-induced phase separation of an acetonitrile-water system can accurately and quantitatively analyze harmful substances in food, such as sulfonylurea herbicides, fluoroquinolones pesticides, and polycyclic aromatic hydrocarbons.

With the improvement of people's overall living standards, the attention of food and drug safety has also increased, which has even become a basic demand for human survival. Therefore, the demand for improving the accuracy of component analysis technology is becoming more and more urgent. At present, the existing inorganic salt-induced phase separation technology is mainly based on empirical and semi-empirical methods, that is, most methods are for quantitative detection and analysis of certain substances. The inorganic salt-induced phase separation technology based on empirical and semi-empirical methods greatly limits its application and development. Therefore, there is an urgent need to propose an improved and efficient inorganic salt-induced phase separation technology to reduce cost and improve extraction effect.

### SUMMARY

The purpose of the present disclosure is to provide a method for efficiently inducing phase separation of a water-organic solvent mixed solution through an inorganic salt. The method of the present disclosure has small errors and good repeatability, and different extraction effects can be selected depending on the production purpose.

The present disclosure provides a method for efficiently inducing phase separation of a water-organic solvent mixed solution through an inorganic salt, comprising the following steps:

A) adding the inorganic salt to the water-organic matter mixed solution, sonicating and then allowing to stand for complete dissolution of the inorganic salt,

wherein the water-organic mixed solution is a water-acetonitrile mixed solution or a water-acetone mixed solution, and

the inorganic salt is one or more of LiCl, NaCl, KCl, CsCl, NaBr, KBr, Li₂SO₄, Na₂SO₄ and MgSO₄;

B) allowing the solution obtained in the step A) to stand in a constant temperature environment until phase separation is completed to obtain a product.

Preferably, the mass of the inorganic salt is 20˜100% of the mass of the inorganic salt that can be dissolved to the greatest extent in the water-organic matter mixed solution.

Preferably, the mass of the inorganic salt is 40˜50% of the mass of the inorganic salt that can be dissolved to the greatest extent in the water-organic matter mixed solution.

Preferably, the volume ratio of water to organic matter in the water-organic matter mixed solution is 7:3˜3:7.

Preferably, the constant temperature environment in the step B) is at 20˜40° C.

Preferably, component analysis is performed on upper and lower phases respectively after the phase separation is completed in the step B).

Preferably, the contents of water and organic phase in the organic-rich phase are determined by using gas chromatography, and the content of the inorganic salt in the organic-rich phase is determined by using atomic emission spectrometry;

The contents of water and organic phase in the water-rich phase are determined by using gas chromatography, and the content of the inorganic salt in the water-rich phase is determined by a mass method.

Preferably, the content of the inorganic salt in the water-rich phase is determined by using a mass method comprising the following steps:

weighing the mass of the water-rich phase solution, drying in a constant temperature oven until there is no flowing liquid, then drying under vacuum until water is completely removed; finally, weighing the mass of the anhydrous inorganic salt to obtain the mass of the inorganic salt in the water-rich phase.

The present disclosure provides a method for efficiently inducing phase separation of a water-organic solvent mixed solution through an inorganic salt, comprising the following steps: A) adding the inorganic salt to the water-organic matter mixed solution, sonicating and then allowing to stand for complete dissolution of the inorganic salt, wherein the water-organic mixed solution is a water-acetonitrile mixed solution or a water-acetone mixed solution, and the inorganic salt is one or more of LiCl, NaCl, KCl, CsCl, NaBr, KBr, Li₂SO₄, Na₂SO₄ and MgSO₄; B) allowing the solution obtained in the step A) to stand in a constant temperature environment until the phase separation is completed to obtain a product. The method of the present disclosure has small error and good repeatability, and the type of the inorganic salt, the addition amount of the inorganic salt as well as the influence of the initial ratio of water-organic solvent on the phase separation effect are fully considered. Based on this, the relatively best separation effect is achieved by using as little inorganic salt as possible.

### BRIEF DESCRIPTION OF THE DRAWINGS

For more clearly illustrating the embodiments of the present disclosure or the technical solutions in the prior art, the drawings used when describing the examples or the prior art will be briefly described hereinafter. Apparently, the drawings in the following description are only examples of the present application, and for one of ordinary skilled in the art, other drawings may be obtained based on the provided drawings without any inventive work.

FIG. 1 shows the schematic diagram of the process of inorganic salt-induced phase separation of a water-organic matter in the present disclosure;

FIG. 2 shows the relation between the volume ratio of upper to lower phases after phase separation following adding the salt and the initial volume ratio of acetonitrile to water (ϕ) in the solution without adding the salt in Example 1 of the present disclosure;

FIG. 3 shows the relation between x_{acetonitrile} (upper) as well as x_{water} (lower) after phase separation following adding the salt and the initial volume ratio of acetonitrile to water (ϕ) in the solution without adding the salt in Example 1 of the present disclosure;

FIG. 4 shows the relation between x_{acetonitrile} (upper) as well as x_{water} (lower) afterphase separation following adding NaCl and the total concentration of the inorganic salt (r) in the system in Example 2 of the present disclosure.

### DETAILED DESCRIPTION

The present disclosure provides a method for efficiently inducing phase separation of a water-organic solvent mixed solution through an inorganic salt, comprising the following steps:

A) adding the inorganic salt to the water-organic matter mixed solution, sonicating and then allowing to stand for complete dissolution of the inorganic salt,

wherein the water-organic matter mixed solution is a water-acetonitrile mixed solution or a water-acetone mixed solution, and

the inorganic salt is one or more of LiCl, NaCl, KCl, CsCl, NaBr, KBr, Li₂SO₄, Na₂SO₄ and MgSO₄;

B) allowing the solution obtained in the step A) to stand in a constant temperature environment until phase separation is completed to obtain a product.

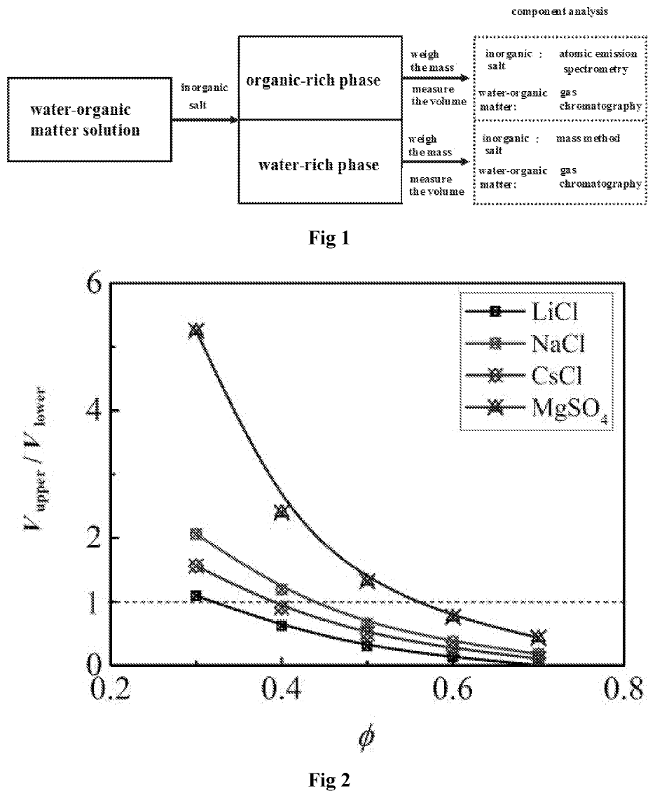

The schematic diagram of the process of the inorganic salt-induced phase separation in the present disclosure is shown in FIG. 1.

In the present disclosure, the inorganic salt is added to the water-organic matter mixed solution, sonicated and then allowed to stand for complete dissolution.

In the present disclosure, the organic matter in the water-organic matter mixed solution is preferably acetonitrile or acetone; the volume ratio of water to organic matter in the water-organic matter mixed solution is 7:3˜3:7, and specifically, it may be 7:3, 6:4, 5:5, 4:6, or 3:7.

A certain ratio of water-organic matter mixed solution is prepared in the present disclosure, preferably using a balance to weigh the mass of acetonitrile and water respectively which are to be mixed. In the present disclosure, it is preferable that determining the density and mass of the upper and lower phases respectively after phase separation, and the volumes of both phases are acquired by calculation. The volume of the solution is not directly measured in the present disclosure because the accuracy of the existing density meter and balance is higher than that of the volume measuring instrument. When the solution volume to be tested is very large, the volume of the solution can also be directly measured.

In the present disclosure, the inorganic salt is preferably one or more of LiCl, NaCl, CsCl and MgSO₄. Specifically, in a specific production process, the following selections may be made depending on different production purposes:

For a mixed solution with a determined volume ratio of water-organic matter, if the largest organic-rich phase volume after phase separation is desired, MgSO₄ is selected as the inorganic salt; if the largest water-rich phase volume is desired, LiCl is selected as the inorganic salt; if both phases volumes with a good separation effect are desired, NaCl is selected as the inorganic salt.

If the best separation effect for the organic-rich phase is desired, LiCl and/or CsCl is selected as the inorganic salt; if the best separation effect for the water-rich phase is desired, MgSO₄ is selected as the inorganic salt; if good separation effect for both phases is desired, NaCl is selected as the inorganic salt.

In the present disclosure, the mass of the inorganic salt is 20˜100% of the mass of the inorganic salt that can be dissolved to the greatest extent in the water-organic matter mixed solution. On the premise of saving raw materials and ensuring the phase separation effect as much as possible, the mass of the added inorganic salt is about 40%-50% of the solubility of the inorganic salt in the water-organic matter mixed solution.

In the present disclosure, the frequency of the ultrasound is preferably 20˜100 KHz, more preferably 40˜80 KHz; and the time of being subjected to ultrasound is preferably 15˜30 min, more preferably 20˜25 min.

After the ultrasonic treatment, the sonicated mixed solution is allowed to stand in the present disclosure. There is no particular restriction on the standing time in the present disclosure, as long as the inorganic salt is completely dissolved in the water-organic matter mixed solution.

Then, in the present disclosure, the solution described above is allowed to stand in a constant temperature environment, until the system is equilibrated and the phases are completely separated, and then the desired product is obtained.

In the present disclosure, the temperature of standing is preferably 20˜40° C., more preferably 25˜35° C.; and the time of standing is preferably above 8 hours to ensure that the complete phase separation in the system can be achieved.

After the phase-separated solution is obtained, in the present disclosure, the upper and lower layer solutions are taken out to measure the volume and mass of the upper and lower phases respectively, and component analysis is performed on the three substances: organic matter, water, and inorganic salt in the upper and lower phases.

The specific steps are as follows:

For the organic-rich phase, the contents of both the organic matter and the water are determined by using gas chromatography, and the content of the inorganic salt is determined by atomic emission spectrometry.

For the water-rich phase, the contents of both the organic matter and water are determined by gas chromatography, and the content of the inorganic salt is determined by a mass method.

Among them, the specific steps of the mass method are as follows: a certain amount of water-rich phase solution is taken to weigh the mass, and subsequently dried in a constant temperature oven at 80° C. until there is no flowing liquid, and then dried at 60° C. under vacuum for 8 hours to further remove the water completely. Finally, the mass of the anhydrous inorganic salt is weighed, and the mass of the inorganic salt in the water-rich phase is obtained according to the mass ratio of water-rich phase to the total water-rich phase solution measured.

To determine the contents of the organic matter and water in both phases, gas chromatography is preferably used in the present disclosure, and there is no particular restriction on the type of gas chromatograph. To determine the content of the inorganic salt in the organic-rich phase, an atomic emission spectrometer is preferably used in the present disclosure because the content of the inorganic salt in the organic-rich phase is too small to be measured with the mass method under the existing experimental accuracy conditions, and there is no particular restriction on the type of atomic emission spectrometer either. In the present disclosure, the methods for measuring volume, density, and mass, as well as the operation methods of gas chromatograph and atomic emission spectrometer are all well known to those skilled in the art.

The present disclosure provides a method for efficiently inducing phase separation of a water-organic solvent mixed solution through an inorganic salt, comprising the following steps: A) adding the inorganic salt to the water-organic matter mixed solution, sonicating and then allowing to stand for complete dissolution of the inorganic salt, wherein the water-organic matter mixed solution is a water-acetonitrile mixed solution or a water-acetone mixed solution, and the inorganic salt is one or more of LiCl, NaCl, KCl, CsCl, NaBr, KBr, Li₂SO₄, Na₂SO₄ and MgSO₄; B) allowing the solution obtained in the step A) to stand in a constant temperature environment until phase separation is completed to obtain a product. The method of the present disclosure has small error and good repeatability, and the type of the inorganic salt, the addition amount of the inorganic salt as well as the influence of the initial ratio of the water-organic solvent on the phase separation effect are fully considered. Based on this, the relatively best separation effect is achieved by using as little inorganic salt as possible.

In order to further illustrate the present disclosure, a method for efficiently inducing phase separation of a water-organic solvent mixed solution through an inorganic salt provided by the present disclosure is described in detail hereinafter in conjunction with the following examples, which are not to be construed as limiting the protection scope of the present invention.

### Example 1

1) Under the condition of 25° C., mixed solutions were prepared in which the volume ratios of water to acetonitrile were 7:3, 6:4, 5:5, 4:6, and 3:7. In this example, the corresponding masses of water and acetonitrile to the above 5 ratios were 6.980 g and 2.328 g, 5.982 g and 3.104 g, 4.986 g and 3.880 g, 3.988 g and 4.656 g, 2.992 g and 5.432 g, respectively. Four parallel groups were prepared for each ratio.

2) NaCl was added to the mixed solutions with the above 5 ratios in one group, and the corresponding masses were 2.459 g, 2.119 g, 1.740 g, 1.386 g and 0.999 g, respectively. The other three groups were added with LiCl, CsCl and MgSO₄.

3) For the above solutions, ultrasonic treatment was performed to dissolve the inorganic salt. Under the condition of 25° C., the concentration of the inorganic salt in the above solutions was close to saturation. They were allowed to stand for more than 8 hours to completely reach phase separation equilibrium.

4) The upper and lower layer solutions were taken separately, and the volume and mass of the upper and lower phases were measured respectively. Taking the NaCl solution as an example, after the phases in the mixed solution were completely separated in which the volume ratios of water to acetonitrile were 7:3, 6:4, 5:5, 4:6 and 3:7, the volume and mass values of the upper and lower phases are shown in Table 1. After phase separation following adding salt such as NaCl, LiCl, CsCl and MgSO₄, the relation between the volumes of the upper and lower phases and the initial volume ratio of acetonitrile to water (ϕ) without adding salt is shown in FIG. 2. The initial volume ratio of acetonitrile to water (ϕ) was calculated by the following equation:

$$ϕ = \frac{{V}_{water}}{{V}_{water} + {V}_{acetonitrile}} ; \qquad Equation 1$$

In Equation 1, V represents the volume of the substance before being mixed.

The results in FIG. 2 indicate that for a mixed solution with a determined volume ratio of water-organic matter, if the largest organic-rich phase volume after phase separation is desired, MgSO₄ is preferred; if the largest water-rich phase volume is preferred, LiCl is selected; if both phases volumes with a good separation effect are desired, NaCl is preferred.

TABLE 1
Data of NaCl-induced phase separation
in Example 1 of the present disclosure

| | | | | | |
|---|---|---|---|---|---|
| V_{water}:V_{acetonitrile} | 7:3 | 6:4 | 5:5 | 4:6 | 3:7 |
| ϕ | 0.7 | 0.6 | 0.5 | 0.4 | 0.3 |
| Mₛₐₗₜ/g | 2.459 | 2.119 | 1.740 | 1.386 | 0.999 |
| V (upper)/ml | 1.6 | 2.9 | 4.2 | 5.7 | 7 |
| m (upper)/g | 1.149 | 2.397 | 3.343 | 4.507 | 5.242 |
| m_{water} (upper)/g | 0.103 | 0.216 | 0.290 | 0.356 | 0.442 |
| m_{acetonitrile} (upper)/g | 1.045 | 2.179 | 3.049 | 4.147 | 4.794 |
| mₛₐₗₜ (upper)/g | 0.00113 | 0.00231 | 0.00335 | 0.00468 | 0.00540 |
| x_{acetonitrile} (upper) | 0.817 | 0.813 | 0.826 | 0.831 | 0.826 |
| V (lower)/ml | 9.2 | 7.8 | 6.4 | 4.8 | 3.4 |
| m (lower)/g | 9.778 | 8.206 | 6.742 | 5.268 | 3.722 |
| m_{water} (lower)/g | 6.752 | 5.758 | 4.805 | 3.676 | 2.602 |
| m_{acetonitrile} (lower)/g | 0.883 | 0.631 | 0.463 | 0.454 | 0.304 |
| mₛₐₗₜ (lower)/g | 2.143 | 1.817 | 1.474 | 1.138 | 0.817 |
| x_{water} (lower) | 0.942 | 0.954 | 0.947 | 0.950 | 0.951 |

5) Component analysis was performed on the three substances: acetonitrile, water, and inorganic salt in the upper and lower phases respectively. Taking the NaCl solution as an example, after the phases in the mixed solution were completely separated in which the volume ratio of water to acetonitrile was 7:3, 6:4, 5:5, 4:6 and 3:7, the mass data of the three components in the upper and lower phases are shown in Table 1. In order to compare the effect of phase separation, the ratios of acetonitrile-water in the upper phase (acetonitrile-rich phase) and the lower phase (water-rich phase) were calculated according to the mass data of acetonitrile and water obtained from component analysis. The upper phase is represented by the mole fraction of acetonitrile (x_{acetonitrile}), and the lower phase is represented by the mole fraction of water (x_{water}). The mole fraction is calculated by the following equation:

$${x}_{i} = \frac{{m}_{i} / {M}_{i}}{{m}_{acetonitrile} / {M}_{acetonitrile} + {m}_{water} / {M}_{water}} ; \qquad Equation 2$$

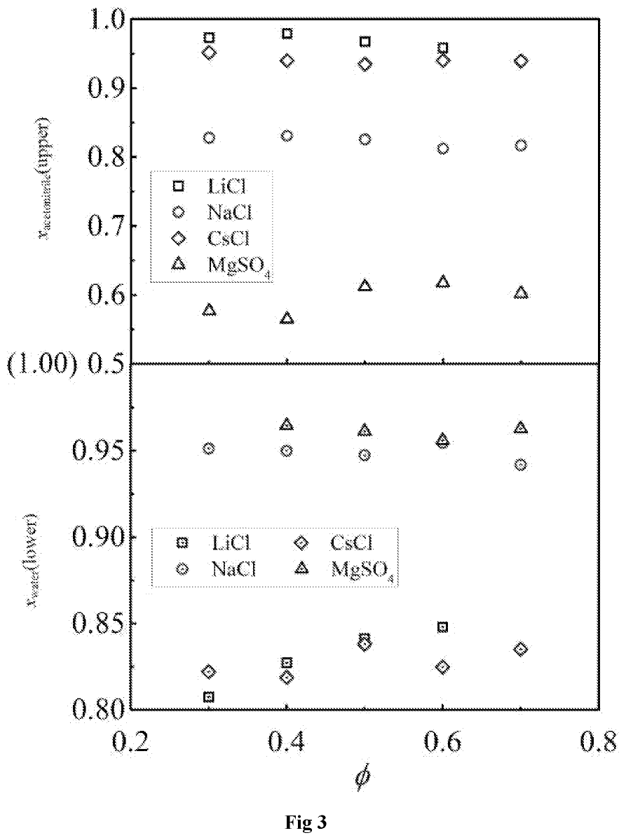

In Equation 2, i represents acetonitrile or water, m is the mass, and M is the relative molecular mass of the corresponding substance. FIG. 3 shows the relation between x_{acetonitrile} (upper) as well as x_{water} (lower) after phase separation following adding salt such as NaCl, LiCl, CsCl and MgSO₄ and the initial volume ratio of acetonitrile to water (ϕ) in the solution without adding salt.

The results in FIG. 3 demonstrate that if the best separation effect for the organic-rich phase is desired, one of the LiCl and CsCl is preferred; if the best separation effect for the water-rich phase is desired, MgSO₄ is selected; if a good separation effect for both phases is desired, NaCl is selected.

### Example 2

1) Under the condition of 25° C., 9 groups of the mixed solution were prepared in which the volume ratio of water to acetonitrile was 5:5. In this example, the corresponding mass of water and acetonitrile was 4.986 g and 3.880 g, respectively.

2) NaCl was added separately to the above 8 groups of mixed solutions. The specific masses were as follows: 0.2251 g, 0.2554 g, 0.47364 g, 0.5088 g, 0.60076 g, 0.72442 g, 0.96169 g, 1.20275 g, and 1.37548 g.

3) For the above solutions, ultrasonic treatment was performed to dissolve the inorganic salt. They were allowed to stand for more than 8 hours to make the phase separation reach equilibrium.

4) The upper and lower layer solutions were taken out, and the volume and mass of the upper and lower phases were measured respectively. The volume and mass values of the upper and lower phases are shown in Table 2.

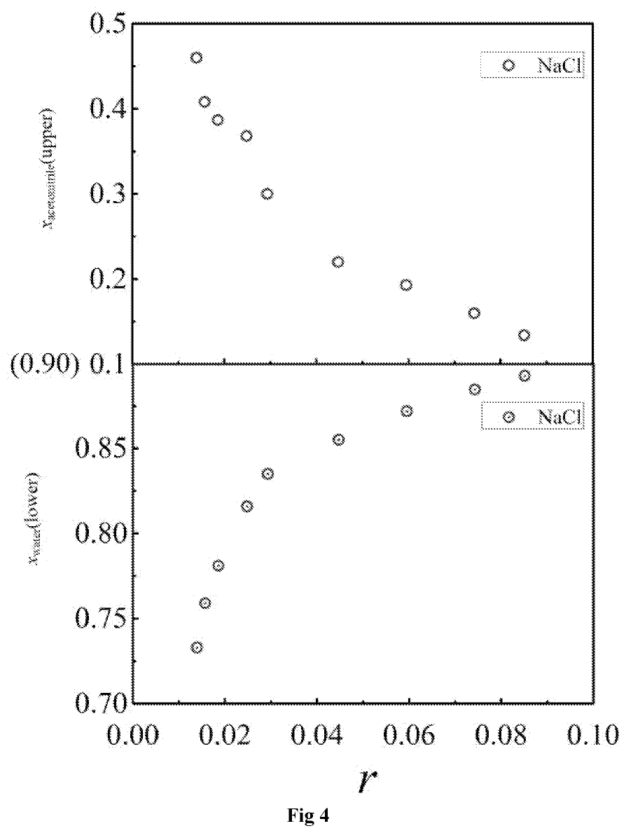

5) Component analysis was performed on the three substances: acetonitrile, water and NaCl in the upper and lower phases respectively. The mass values of the three components in the upper and lower phases are shown in Table 2. In order to compare the influence of NaCl concentration on the effect of phase separation, the ratios of acetonitrile to water in the upper phase (acetonitrile-rich phase) and the lower phase (water-rich phase) were calculated according to the mass relation between acetonitrile and water obtained from component analysis. The upper phase is represented by the mole fraction of acetonitrile (x_{acetonitrile}) and the lower phase is represented by the mole fraction of water (x_{water}). The mole fraction was calculated by equation 2 in Example 1. The values of x_{acetonitrile} and x_{water} are shown in Table 2, and FIG. 4 shows the relation between x_{acetonitrile} (upper) as well as x_{water} (lower) after phase separation following adding salt and the total concentration of inorganic salt (r) in the system. The total concentration of inorganic salt in the system was represented as the ratio of the respective total moles of inorganic salt and water in the system:

$$r = \frac{{m}_{salt} / {M}_{salt}}{{m}_{water} / {M}_{water}} ; \qquad Equation 3$$

The results in FIG. 4 demonstrate that the effect of phase separation is the best when the mass of NaCl added was close to the mass of NaCl that can be dissolved to the greatest extent in the mixed solution in which the volume ratio of acetonitrile to water was 5:5 separation effect; if the principle of “the relatively best separation effect is achieved under the condition that the amount of an inorganic salt added is as small as possible” is considered, the mass of NaCl chosen is 0.72442 g, which is 41.6% of the mass of NaCl that can be dissolved to the greatest extent.

TABLE 2
Related data of NaCl-induced phase separation in Example 2 of the present disclosure

| Group | 1 | 2 | 3 | 4 | 5 | 6 | 7 | 8 | 9 |
|---|---|---|---|---|---|---|---|---|---|
| Mₛₐₗₜ/g | 0.2251 | 0.2544 | 0.30038 | 0.40024 | 0.47364 | 0.72442 | 0.96169 | 1.20275 | 1.37548 |
| r | 0.0139 | 0.0157 | 0.0186 | 0.0248 | 0.0293 | 0.0447 | 0.0595 | 0.0743 | 0.0851 |
| m (upper)/g | 1.216 | 2.061 | 2.414 | 2.878 | 2.868 | 3.066 | 3.206 | 3.315 | 3.333 |
| m_{water} (upper)/g | 0.328 | 0.476 | 0.5215 | 0.578 | 0.446 | 0.339 | 0.303 | 0.255 | 0.211 |
| m_{acetonitrile} | 0.877 | 1.5745 | 1.8825 | 2.265 | 2.376 | 2.720 | 2.897 | 3.054 | 3.117 |
| (upper)/g | | | | | | | | | |
| mₛₐₗₜ (upper)/g | 0.0111 | 0.01002 | 0.00999 | 0.0096 | 0.00876 | 0.00691 | 0.00610 | 0.00521 | 0.00494 |
| x_{acetonitrile} | 0.460 | 0.408 | 0.387 | 0.368 | 0.300 | 0.220 | 0.193 | 0.160 | 0.134 |
| (upper) | | | | | | | | | |
| m (lower)/g | 7.737 | 7.534 | 6.770 | 6.476 | 6.457 | 6.482 | 6.602 | 6.793 | 6.860 |
| m_{water} (lower)/g | 4.085 | 4.24 | 4.023 | 4.023 | 4.109 | 4.145 | 4.230 | 4.326 | 4.299 |
| m_{acetonitrile} | 3.396 | 3.061 | 2.525 | 2.066 | 1.854 | 1.597 | 1.420 | 1.275 | 1.177 |
| (lower)/g | | | | | | | | | |
| mₛₐₗₜ (lower)/g | 0.216 | 0.233 | 0.387 | 0.387 | 0.494 | 0.740 | 0.952 | 1.193 | 1.384 |
| x_{water} (lower) | 0.733 | 0.759 | 0.781 | 0.816 | 0.835 | 0.855 | 0.872 | 0.885 | 0.893 |

The foregoing is preferred embodiments of the present disclosure, however, it should be noted that some improvements and modifications can be made thereto by those ordinary skilled in the art without departing from the principles of the present disclosure, and these improvements and modifications should also be deemed to be within the protection scope of the present invention.

1. A method for efficiently inducing phase separation of a water-organic solvent mixed solution through an inorganic salt, comprising the following steps:
A) adding the inorganic salt to the water-organic matter mixed solution, sonicating and then allowing to stand for complete dissolution of the inorganic salt,
wherein the water-organic matter mixed solution is a water-acetonitrile mixed solution or a water-acetone mixed solution, and
the inorganic salt is one or more of LiCl, NaCl, KCl, CsCl, NaBr, KBr, Li₂SO₄, Na₂SO₄ and MgSO₄;
B) allowing the solution obtained in the step A) to stand in a constant temperature environment until phase separation is completed to obtain a product.

2. The method according to claim 1, wherein the mass of the inorganic salt is 20˜100% of the mass of the inorganic salt that can be dissolved to the greatest extent in the water-organic matter mixed solution.

3. The method according to claim 1, wherein the mass of the inorganic salt is 40˜50% of the mass of the inorganic salt that can be dissolved to the greatest extent in the water-organic matter mixed solution.

4. The method according to claim 1, wherein the volume ratio of water to organic matter in the water-organic matter mixed solution is 7:3˜3:7.

5. The method according to claim 1, wherein the constant temperature environment in the step B) is 20˜40° C.

6. The method according to claim 1, wherein component analysis is performed on upper and lower phases respectively after the phase separation is completed in the step B).

7. The method according to claim 6, wherein for organic-rich phase, the contents of water and organic phase in the organic-rich phase are determined by using gas chromatography, and the content of the inorganic salt in the organic-rich phase is determined by using atomic emission spectrometry;
for water-rich phase, the contents of water and organic phase in the water-rich phase are determined by using gas chromatography, and the content of the inorganic salt in the water-rich phase is determined by using a mass method.

8. The method according to claim 7, wherein the content of the inorganic salt in the water-rich phase is determined by using a mass method comprising the steps of:
weighing the mass of the water-rich phase solution, drying in a constant temperature oven until there is no flowing liquid, then drying under vacuum until water is completely removed; and finally, weighing the mass of the anhydrous inorganic salt to obtain the mass of the inorganic salt in the water-rich phase.
